(19) United States
(12) Patent Application Publication
(10) Pub. No.: US 2005/0266190 A1
(43) Pub. Date: Dec. 1, 2005

(54) Copolyetherester composition and multilayer structure thereof

(76) Inventors: David D. Zhang, Wilmington, DE (US); Jacques Andre, Annemasse (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/133,563

(22) Filed: May 20, 2005

Related U.S. Application Data
(60) Provisional application No. 60/574,298, filed on May 25, 2004.

(51) Int. Cl. B65D 1/00; B32B 1/08

(52) U.S. Cl. 428/35.7; 428/35.2; 428/36.9

(57) ABSTRACT

Disclosed is a composition comprising, or produced from, about 90 to about 99.9 weight % of at least one polyester-polyether block copolymer and from about 0.1 to about 10 weight % of a nucleating agent wherein the polyester-polyether block copolymer comprises repeat units derived from about 30 to about 70 weight % of 1,4-butylene terephthalate and from about 10 to about 70 weight % of poly(tetramethylene ether) terephthalate. Also disclosed is a multilayer structure comprising or produced from the composition. Further disclosed is an article such as pouch, tubing, blow molded bottle, or thermoformed tray comprising or produced from the multilayer structure.

The invention claims priority to U.S. Provisional Application No. 60/574,298, filed May 25, 2004, the entire disclosure of which is incorporated herein by reference.

This invention relates to a copolyetherester composition comprising a nucleating agent, to a multilayer structure comprising or produced from the composition such as multilayer films, to a pouch such as one for storing and transferring medical solutions, and to film, tubing, blow molded bottles, or thermoformed tray.

### BACKGROUND OF THE INVENTION

Currently, it is common practice to supply medical solutions for parenteral (e.g., intravenous or IV) administration in the form of disposable, flexible pouches. One class of such pouches is commonly referred to as an “IV bag”. These pouches desire collapsibility, optical clarity and transparency, high-temperature heat-resistance (steam sterilizable), and sufficient mechanical strength to withstand the rigors of the use environment. Medical solution pouches also provide a sufficient barrier to the passage of moisture vapor and other gases to prevent oxidation and concentration changes of the solution contained therein.

Collapsibility ensures proper and complete drainage of the pouch. In order for the pouch to be collapsible, the film from which the pouch is made is flexible.

Optical clarity and transparency allow for a visual inspection of the solution contained within the pouch to provide a cursory determination that the medical solution to be administered is of the proper type and has not deteriorated or become contaminated.

High-temperature heat-resistance of the film allows for heat-sterilization of solution-containing medical pouches. Heat sterilization typically occurs in steam-heated autoclaves at about 116 to 130° C. (240 to 266° F.) for about 15 to 30 minutes.

Medical solution pouches also have sufficient mechanical strength to withstand the abuse that is typically encountered in the use environment.

Flexible pouches for medical solution packaging have been made from highly plasticized polyvinyl chloride (PVC) compositions. Plasticizer can migrate from the PVC pouch and into the solution contained within the pouch to contaminate the solution by potentially toxic material. Migration may also cause stiffening or become brittle of pouches over time.

Alternatives to PVC pouches are formed from multilayer films including exterior layers such as abuse-resistant layer and heat-seal layer, core or interior layer imparting strength and flexibility or contributing to the gas impermeability of the film. See, e.g., U.S. Pat. Nos. 4,891,253; 4,939,009; 5,695,840; 5,789,046; 6,027,776; and 6,479,116 and US Patent Application US2001049001.

A challenge in the design and manufacture of films used to produce medical solution pouches is the ability of the film to provide the above performance characteristics after the pouch has been heat-sterilized. For example, heat-sterilization may affect the optical properties or gas permeability, of medical solution pouches.

Accordingly, a need exists to provide a multilayer film to replace PVC. Though a coextruded film containing a polyester-polyether block copolymer (a “copolyetherester”) or blends thereof offers flexibility, temperature resistance and mechanical strength needed for IV pouch applications, such copolymers may not have sufficient clarity. Certain metal salts of organic acids can function as nucleating agents that speed up the nucleating process, which in turn allows the copolyetherester to form much smaller size crystals, providing improved clarity. See, e.g., U.S. Pat. Nos. 5,496,291; 5,733,268; 5,919,173; 6,348,049; EP781565B1; and Japanese Patent Applications JP11158302A, JP11158362A, JP11162279A, JP52004549A, JP52004550A and JP52004551A.

### SUMMARY OF THE INVENTION

The invention includes a composition comprising, or produced from, about 90 to about 99.9 weight % of at least one polyester-polyether block copolymer and about 0.1 to about 10, or 0.1 to 5, weight % of a nucleating agent in which the copolymer comprises repeat units derived from about 30 to about 70, 30 to 40, or 23 to 27, weight % of 1,4-butylene terephthalate; about 10 to about 70, 60 to 70, or 10 to 15, weight % of poly(tetramethylene ether) terephthalate; and optionally about 3 to about 7 weight % of poly(tetramethylene ether) isophthalate.

The composition can further comprise from about 0.1 to about 10 weight % of an alkali metal salt of a carboxylic acid, di-(optionally substituted)-benzylidene sorbitol or an ethylene/acid copolymer partially neutralized with metal ions.

The invention also includes a multilayer structure comprising, or produced from, at least one interior layer, a first exterior layer, and optionally a second exterior layer in which the at least one interior layer can comprise or be produced from ethylene/α-olefin copolymer having a density ranging from about 0.86 to about 0.94 g/cm³, ethylene/alkyl acrylate copolymer, or combinations thereof; the first exterior layer can comprise or be produced from a homopolymer or copolymer of polypropylene, a blend of homopolymer or copolymer of polypropylene and elastomer, high density polyethylene, copolyester, or combinations of two or more thereof; the second exterior layer can comprise or be produced from a second composition; the second composite can comprise or be produced from about 90 to about 99.9 weight % of at least one polyester-polyether block copolymer and about 0.1 to 10 about weight % of a nucleating agent.

The invention further includes pouches (e.g., pouches for storing and transferring medical solutions), tubing (e.g., tubing for transferring medical solutions), blow molded bottles, or thermoformed trays, each made from or comprising the compositions and multilayer structures disclosed above.

### DETAILED DESCRIPTION OF THE INVENTION

The entire disclosure of each patent disclosed is herein incorporated by reference.

The term “optionally substituted” in connection with a chemical moiety refers to moieties that are unsubstituted or have at least one non-hydrogen substituent. The term “film” is used in a generic sense to include plastic web, regardless of whether it is film or sheet. The term “film” also refers to a thermoplastic material, generally in sheet or web form, having one or more layers of polymeric materials which may be bonded together by any suitable means well known in the art.

The phrase “lay-flat film” refers to a film that has been extruded as a wide, thin-walled, circular tube, usually blown, cooled, then gathered by converging sets of rollers and wound up in flattened form. The phrase “lay-flat width,” refers to half of the circumference of the inflated film tube.

Thermoplastic compositions are polymeric materials that can flow when heated under pressure. Melt index (MI) is the mass rate of flow of a polymer through a specified capillary under controlled conditions of temperature and pressure. Melt indices are determined according to ASTM 1238 at 190° C. using a 2160 g weight, with values of MI reported in grams/10 minutes.

“Olefin” refers to any monounsaturated aliphatic hydrocarbons of the general formula CₙH₂ₙ or compounds containing more than one double bond in the molecule such as a diolefin or diene, e.g., butadiene.

“Polyolefin” refers to olefin polymers and copolymers, especially ethylene and propylene polymers and copolymers, and to polymeric materials having at least one olefinic comonomer, such as ethylene vinyl acetate copolymer and ionomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, modified polymers of the foregoing, and the like. Modified polyolefins include modified polymers prepared by copolymerizing the homopolymer of the olefin or copolymer thereof with an unsaturated carboxylic acid, e.g., maleic acid, fumaric acid or the like, or a derivative thereof such as the anhydride, ester metal salt or the like.

“Interior layer” refers to any layer of a multilayer film having both of its principal surfaces directly adhered to another layer of the film.

The term “core” or “core layer”, as applied to multilayer films, refers to any interior film layer which has a primary function other than serving as an adhesive or compatibilizer for adhering two layers to one another. Usually, the core layer or layers provide the multilayer film with a desired level of strength and barrier properties, i.e., modulus, and/or optics, and/or added abuse resistance, and/or specific impermeability.

“Adhesive layer” or “tie layer” refers to any interior layer having the primary purpose of adhering two layers to one another.

“Exterior layer” refers to any layer of a multilayer film having only one of its principal surfaces directly adhered to another layer of the film. In the multilayer films of the present invention, there are two exterior layers, each of which has a principal surface adhered to only one other layer of the multilayer film. The other principal surface of each of the two exterior layers forms one of the two principal outer surfaces of the multilayer film.

“Inside layer” refers to an exterior film layer of a multilayer film packaging a product that is closest to the product, relative to the other layers of the multilayer film. “Inside layer” also can refer to the innermost layer of a plurality of concentrically arranged layers simultaneously coextruded through an annular die.

“Outside layer” refers to an exterior layer of a multilayer film packaging a product that is furthest from the product, relative to the other layers of the multilayer film. “Outside layer” also can refer to the outermost layer of a plurality of concentrically arranged layers simultaneously coextruded through an annular die.

“Directly adhered”, as applied to film layers, means adhesion of the subject film layer to the object film layer, without a tie layer, adhesive, or other layer. The word “between”, as applied to a film layer expressed as being between two other specified layers, includes both direct adherence of the subject layer between to the two other layers it is between, as well as including a lack of direct adherence to either or both of the two other layers the subject layer is between, i.e., one or more additional layers can be imposed between the subject layer and one or more of the layers the subject layer is between.

“Seal” refers to any seal of a first region of a film surface to a second region of a film surface, wherein the seal is formed by heating the regions to at least their respective seal initiation temperatures. The sealing can be performed by any one or more of a wide variety of manners, such as using a heated bar, hot air, hot wire, infrared radiation, ultrasonic sealing, radio frequency sealing, impulse seals, etc.

“Seal layer,” “sealing layer,” “heat seal layer,” or “sealant layer,” refers to an exterior film layer, or layers, involved in the sealing of the film to itself, another film layer of the same or another film, and/or another article that is not a film. In general, up to the outer 3 mils of a film can be involved in the sealing of the film to itself or another layer. With respect to packages having only fin-type seals, as opposed to lap-type seals, “sealant layer” generally refers to the inside film layer of a package, as well as supporting layers within 3 mils of the inside surface of the sealant layer, the inside layer frequently also serving as a product contact layer in the packaging of products such as medical solutions. With respect to packages constructed from tubular films (i.e. those films prepared by coextrusion through an annular die), “sealant layer” generally refers to the inside film layer of a package, as well as supporting layers within 3 mils of the inside surface of the sealant layer, the inside layer frequently also serving as a product contact layer in the packaging of products such as medical solutions. In general, sealant layers employed in the packaging art have included thermoplastic polymers, such as polyolefin, polyamide, polyester, and polyvinyl chloride.

Nucleated Copolyetherester Compositions

A copolyetherester (also known as a poly-ether-ester block copolymer, block poly-ether-ester, polyester elastomer, thermoplastic poly-ether-ester) is a block copolymer containing both polyether and ester blocks. Copolyetheresters are available under the tradenames Hytrel® from E. I. du Pont de Nemours and Company (DuPont), Arnitel from DSM and Pelprene from Toyobo. Copolyetheresters are well known materials generally used, for example, in clothing generally referred to as polyester clothing.

Copolyetheresters are discussed in detail in U.S. Pat. Nos. 3,651,014; 3,766,146; and 3,763,109. Copolyetherester polymers include the polyether segment obtained by polymerization of tetrahydrofuran (i.e. poly(tetramethylene ether)) and the polyester segment obtained by polymerization of tetramethylene glycol and phthalic acid (i.e. 1,4-butylene terephthalate). The more polyether units incorporated into the copolyetherester, the softer the polymer. The poly(tetramethylene ether) glycol used to make the copolyetherester can have a molecular weight of from about 500 to about 3500, or about 800 to about 2500.

Copolyetheresters include polyester-polyether block copolymers comprising repeat units derived from 30 to 70 weight % of 1,4-butylene terephthalate and from 10 to 70 weight % of poly(tetramethylene ether) terephthalate.

Copolyetherester can comprise repeat units derived from 55 to 60 weight % of 1,4-butylene terephthalate, from 23 to 27 weight % of 1,4-butylene isophthalate, from 10 to 15 weight % of poly(tetramethylene ether) terephthalate, and from 3 to 7 weight % of poly(tetramethylene ether) isophthalate. The poly(tetramethylene ether) glycol used to make the copolyetherester may have a molecular weight of from about 800 to about 1200.

Copolyetherester can also comprise repeat units derived from 30 to 40 weight % 1,4-butylene terephthalate, and from 60 to 70 weight % poly(tetramethylene ether) terephthalate. The poly(tetramethylene ether) glycol used to make the copolyetherester preferably has a molecular weight of from 1500 to about 2500.

Copolyetheresters have low temperature properties (freezing) and are impervious to chemicals, oils and tissue. They do not have sufficient clarity to be suitable for IV pouches. Certain materials such as metal salts of organic acids can function as nucleating agents that speed up the nucleating process, which in turn allows the copolyetherester to form much smaller size crystals, providing improved clarity.

The nucleating agent can include an alkali metal salt of carboxylic acid, di-((optionally substituted)benzylidene) sorbitol, ethylene/acid copolymer partially neutralized with metal ion (ionomer), talc, low molecular weight polypropylene, or combinations of two or more thereof.

Organic acids that may be employed include aliphatic, mono-functional (saturated, unsaturated, or multi-unsaturated) organic acids, particularly those having from 6 to 36 carbon atoms such as aliphatic, mono-functional organic acid(s) having from 6 to 36 carbon atoms. Fatty acids are preferred. Organic acids include caproic acid, caprylic acid, capric acid, lauric acid, stearic acid, behenic acid, erucic acid, oleic acid, and linoleic acid. Salts of these organic acids can provide the nucleating agents such as sodium stearate.

Other nucleating agents may also be used such as di-((optionally substituted)-benzylidene) sorbitols (DBS) and partially neutralized ethylene/acid copolymers. Di-(optionally substituted)-benzylidene sorbitols of note are di-benzylidene sorbitol and di-(paramethylbenzylidene) sorbitol.

Ethylene/α-Olefin Copolymer

“Ethylene/α-olefin copolymer” designates copolymers of ethylene with one or more comonomers selected from C₃ to C₂₀ α-olefins, such as 1-butene, 1-pentene, 1-hexene, 1-octene, methylpentene and the like, in which the polymer molecules comprise long chains with relatively few side chain branches. These polymers can be obtained by low-pressure polymerization processes and the side branching which is present will be short compared to non-linear polyethylenes (e.g., LDPE, a polyethylene homopolymer). Ethylene/α-olefin copolymers generally have a density in the range of from about 0.86 g/cc to about 0.94 g/cc.

“Heterogeneous ethylene/α-olefin copolymer” refers to ethylene/α-olefin copolymerization products varied in molecular weight and composition distribution, and which are prepared using conventional Ziegler-Natta or other heterogeneous catalysts. See, e.g. U.S. Pat. Nos. 4,302,565 and 4,302,566.

Examples of heterogeneous ethylene/α-olefins include linear low-density polyethylene (LLDPE), linear medium density polyethylene (LMDPE), very low-density polyethylene (VLDPE), and ultra-low density polyethylene (ULDPE). LLDPE is generally understood to include that group of heterogeneous ethylene/α-olefin copolymers that fall into the density range of about 0.915 to about 0.94 g/cc. Sometimes linear polyethylene in the density range from about 0.926 to about 0.94 is referred to as LMDPE. Lower density heterogeneous ethylene/α-olefin copolymers are VLDPE (ethylene/butene copolymers with a density ranging from about 0.88 to about 0.91 g/cc) and ULDPE (ethylene/octene copolymers).

“Homogeneous ethylene/α-olefin copolymer” refers to ethylene/α-olefin copolymerization products of relatively narrow molecular weight distribution and relatively narrow composition distribution. Homogeneous ethylene/α-olefin copolymers are structurally different from heterogeneous ethylene/α-olefin copolymers, in that homogeneous ethylene/α-olefins exhibit a relatively even sequencing of comonomers within a chain, a mirroring of sequence distribution in all chains, and a similarity of length of all chains, i.e., a narrower molecular weight distribution. Homogeneous ethylene/α-olefin copolymers are typically prepared using metallocene, or other single-site type catalysts, rather than using Ziegler Natta catalysts.

Homogeneous ethylene/α-olefin copolymers may be characterized by molecular weight distribution (M_{w}/Mₙ), composition distribution breadth index (CDBI), and narrow melting point range and single melt point behavior. The M_{w}/Mₙ, also known as polydispersity, may be determined by gel permeation chromatography. Homogeneous ethylene/α-olefin copolymers generally have a M_{w}/Mₙ of less than 2.7; preferably from about 1.9 to 2.5; more preferably, from about 1.9 to 2.3. The composition distribution breadth index (CDBI) of such homogeneous ethylene/α-olefin copolymers will generally be greater than about 70%. The CDBI is defined as the weight percent of the copolymer molecules having a comonomer content within 50% (i.e., plus or minus 50%) of the median total molar comonomer content. The CDBI of linear polyethylene, which does not contain a comonomer, is defined to be 100%. CDBI determination clearly distinguishes the homogeneous copolymers used in the present invention (narrow composition distribution as assessed by CDBI values generally above 70%) from VLDPEs available commercially which generally have a broad composition distribution as assessed by CDBI values generally less than 55%. The CDBI of a copolymer is readily calculated from data obtained from techniques known in the art, such as, for example, temperature rising elution fractionation as described, for example, in Wild et al., J. Poly. Sci. Poly. Phys. Ed., 1982, Vol. 20, p. 441. Homogeneous ethylene/α-olefin copolymers in the multilayer films of the present invention also exhibit a relatively narrow melting point range, in comparison with “heterogeneous copolymers”, i.e., polymers having a CDBI of less than 55%. Homogeneous ethylene/α-olefin copolymers exhibit an essentially singular melting point characteristic, with a peak melting point (Tₘ), as determined by Differential Scanning Calorimetry (DSC), of from about 60° C. to about 110° C. “Essentially single melting point” means that at least about 80%, by weight, of the material corresponds to a single Tₘ peak at a temperature within the range of from about 60° C. to about 110° C., and essentially no substantial fraction of the material has a peak melting point in excess of about 115° C., as determined by DSC analysis. DSC measurements are well known to one skilled in the art. The presence of higher melting peaks is detrimental to film properties such as haze.

Processes for preparing and using homogeneous polymers are disclosed in U.S. Pat. Nos. 5,206,075, 5,241,031, 5,272,236, and 5,278,272, all of which are hereby incorporated by reference herein in their respective entireties.

The ethylene/α-olefin copolymer has a density ranging from about 0.89 to about 0.92 g/cc, alternatively from about 0.90 to about 0.91 g/cc.

Commercially-available examples of homogeneous ethylene/α-olefin copolymers include metallocene-catalyzed EXACT™ obtainable from the Exxon Chemical Company, of Baytown, Tex.; TAFMER™ linear homogeneous copolymer obtainable from the Mitsui Petrochemical Corporation; long-chain branched, metallocene-catalyzed homogeneous copolymers available from The Dow Chemical Company, known as AFFINITY™ resins; and copolymer obtainable from DuPont Dow Elastomers, known as ENGAGE™ resins. Particularly useful includes ethylene/octene copolymers containing 12% octene, with MI of about 1.

Interior layer may comprise a blend of two or more homogeneous ethylene/α-olefin copolymers wherein the density of the blend ranges from about 0.86 to about 0.94, about 0.89 to about 0.92, or about 0.90 to about 0.91, g/cm³.

The MI (ASTM D-1238) of the copolymer or blend of copolymers can be less than 20, less than 10, less than 2.2, or between 0.1 and 1.5. A suitable one can have a density of approximately 0.90 g/cc and MI of approximately 1.0; 0.91 g/cc and MI of approximately 1.0; a density of approximately 0.91 g/cc and MI of approximately 3.5; and a density of approximately 0.915 g/cc and MI of approximately 1.0.

The First Exterior Layer

A first exterior layer can comprise a material selected from the group consisting of homopolymer or copolymer of polypropylene, a blend of homopolymer or copolymer of polypropylene and elastomer, high density polyethylene, and copolyester.

Polypropylene (PP) polymers include homopolymers, random copolymers, block copolymers and terpolymers of propylene. Copolymers of propylene include copolymers of propylene with other olefins such as ethylene, 1-butene, 2-butene and the various pentene isomers, etc. and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymer of propylene and ethylene. The term “polypropylene” refers to any or all of the polymers comprising propylene described above.

Polypropylene homopolymers or random copolymers can be manufactured by any known process. For example, polypropylene polymers can be prepared in the presence of catalyst systems of the type known as Ziegler-Natta, based on organometallic compounds and on solids containing titanium (+4) trichloride. Polypropylene polymers can also be prepared using metallocene, or other single-site type catalysts, rather than using Ziegler Natta catalysts.

Block copolymers can be manufactured similarly, except that propylene is generally first polymerized by itself in a first stage and propylene and additional comonomers such as ethylene are then polymerized, in a second stage, in the presence of the polymer obtained during the first. Each of these stages can be carried out, for example, in suspension in a hydrocarbon diluent, in suspension in liquid propylene, or else in gaseous phase, continuously or noncontinuously, in the same reactor or in separate reactors.

Additional information relating to block copolymers and to their manufacture may be found particularly in chapters 4.4 and 4.7 of the work “Block Copolymers” edited by D. C. Allport and W. H. Janes, published by Applied Science Publishers Ltd in 1973.

The homopolymer or copolymer of PP can be propylene/ethylene copolymer having from about 2 to about 10 or about 4 to about 6 wt % ethylene. A suitable propylene/ethylene copolymer is commercially available from the Fina Oil & Chemical Company under the tradename Z9450, and has an ethylene content of about 6 wt %. Others include Basell under the tradenames Adsyl™ and Profax™, PLTD 665 from Exxon. PP used in this layer may be of any of the available types, i.e., isotactic, syndiotactic, or atactic.

PP polymers may be blended with elastomers. The elastomers may include styrene-ethylene-butylene-styrene block copolymer (SEBS), styrene-butadiene-styrene block copolymer (SBS), styrene-isoprene-styrene block copolymer (SIS), ethylene-propylene rubber (EPM), ethylene-propylene-diene terpolymer (EPDM), or combinations of two or more thereof. SEBS is commercially available, e.g., from the Shell Chemical Co. as Kraton™ G-1650, G-1652, and G-1657X. SBS is commercially available, e.g., from Shell as Kraton™ D-1101, D-1102, D-1300C, D4122, D4141, D4455X, and D4460X. SIS is commercially available, e.g., from Shell as Kraton™ D-1107, D-1111, D-1112, and D-1117. EPM is commercially available, e.g., from Exxon as Vistalon™ 719 or 503. EPDM is commercially available, e.g., from Exxon as Vistalon™ 3708.

Suitable, pre-prepared blends of PP and elastomer are also commercially available such as Z4650 from Horizon Polymers (blend of 80 wt % Z9450 (propylene/ethylene copolymer as described above) and 20 wt % Kraton™ G-1652 (SEBS as described above)).

The first exterior layer preferably comprises a homopolymer or copolymer of PP or a blend of homopolymer or copolymer of PP and elastomer. PP imparts good heat-resistance to the exterior layer while the elastomer provides creep- and impact-resistance thereto.

Homogeneous PP prepared using metallocene catalysis can be desirable for it may provide less extractable impurities than heterogeneous PP.

Multilayer Structures

The multilayer structures can be in the form of films, such as blown films, cast films, laminated films, sheets and molded articles. Films can exhibit minimal loss in clarity after steam sterilization (121° C. for 30 minutes).

As disclosed, the structure can comprise at least three layers, but is not limited to only three layers. Other interior layers may be present in addition to the ethylene/α-olefin copolymer layer disclosed above. The additional interior layers may, for example, provide adhesion to the exterior layers (a tie layer) and/or provide barrier properties (a barrier layer) to the structure.

With a three-layer film, the first and second exterior layers are adhered directly to the interior ethylene/α-olefin copolymer layer (i.e., without an intervening adhesive layer). In another example, the first and second exterior layers are adhered directly to the interior ethylene/alkyl acrylate copolymer layer (i.e., without an intervening adhesive layer).

Accordingly, a multilayer structure can comprise or be produced from (1) a first exterior layer comprising a material selected from the group consisting of a homopolymer or copolymer of polypropylene; (2) an interior adhesive layer comprising at least one ethylene/alkyl acrylate copolymer; (3) a second exterior layer comprising a composition comprising or produced from (a) from 90 to 99.9 weight % of one or more polyester-polyether block copolymers; and (b) from 0.1 to 10 weight % of a nucleating agent.

In a four-layer film, the film includes an additional layer, preferably an adhesive layer, which is positioned between and in adherence with the interior ethylene/α-olefin copolymer layer and the first exterior layer. When the multilayer film of the present invention is a four-layer structure, the first exterior layer preferably comprises a homopolymer or copolymer of polypropylene or a blend of homopolymer or copolymer of polypropylene and elastomer. The adhesive layer may comprise a material selected from the group consisting of ethylene/α-olefin copolymer (homogeneous or heterogeneous) having a density of less than or equal to 0.92 g/cc, a blend of homogeneous ethylene/α-olefin copolymer having a density ranging from about 0.89 to about 0.92 g/cc and the material from which the first exterior layer is formed, anhydride-modified ethylene/vinyl acetate copolymer, and anhydride-modified ethylene/methyl acrylate copolymer. Alternatively, non-modified ethylene/vinyl acetate copolymers or ethylene/alkyl acrylate copolymers can be used in the adhesive layer.

Each of the foregoing materials is compatible with the material from which the interior layer is formed (e.g., a homogeneous ethylene/α-olefin copolymer). Thus, the particular material that is selected for adhesive layer will depend upon the composition of first exterior layer. For example, when the first exterior layer comprises a blend of homopolymer or copolymer of polypropylene (e.g., propylene/ethylene copolymer) and elastomer (e.g., SEBS), first adhesive layer may comprise ethylene/α-olefin copolymer having a density of less than or equal to 0.92 g/cc, or less than or equal to 0.91 g/cc. Such a material can adhere well to the interior layer and the first exterior layer and is believed to provide improved pressure-cuff performance for medical solution pouches.

The most widely available ethylene/α-olefin copolymers with densities of 0.89 g/cc or less are homogeneous, e.g., metallocene-catalyzed. Such copolymers are commercially available from resin manufacturers such as the Dow Chemical Company and the Exxon Chemical Company. Exemplary ethylene/α-olefin copolymers with densities of 0.89 g/cc or less include ENGAGE™ EG 8150, an ethylene/octene copolymer commercially available from Dow and having a density of 0.868 g/cc (ASTM D-792), a melt index of 0.5 dg/min. (ASTM D-1238), and 25% octene (ASTM D-2238, Method B); ENGAGE™ EG 8100, an ethylene/octene copolymer having a density of 0.87 g/cc (ASTM D-792), a melt index of 1 dg/min. (ASTM D-1238), and 24% octene (ASTM D-2238, Method B); and ENGAGE™ EG 8200, an ethylene/octene copolymer having a density of 0.87 g/cc (ASTM D-792), a melt index of 5 dg/min. (ASTM D-1238), and 24% octene (ASTM D-2238, Method B).

In a five-layer structure, the film includes two additional layers. The additional layers can be adhesive layers. When the multilayer film of the present invention has a five-layer structure, the first exterior layer preferably comprises a homopolymer or copolymer of polypropylene or a blend of homopolymer or copolymer of polypropylene and elastomer. The second exterior layer comprises a nucleated copolyetherester as described herein. In this instance, the first exterior layer may serve as a heat-seal layer while the second exterior layer serves as an abuse-resistant layer.

The first of the adhesive layers is positioned between and in adherence with the interior ethylene/α-olefin copolymer layer and the first exterior layer. This first adhesive layer may comprise a material selected from the group consisting of ethylene/α-olefin copolymer having a density of less than or equal to 0.92 g/cc, a blend of homogeneous ethylene/α-olefin copolymer having a density ranging from about 0.89 to about 0.92 g/cc and the material from which the first exterior layer is formed, anhydride-modified ethylene/vinyl acetate copolymer, and anhydride-modified ethylene/methyl acrylate copolymer.

The second adhesive layer preferably comprises a material selected from the group consisting of ethylene/alkyl acrylate copolymers (e.g. ethylene/methyl acrylate copolymers), anhydride-modified ethylene/vinyl acetate copolymers, anhydride-modified ethylene/methyl acrylate copolymers, anhydride-modified ethylene/ethyl acrylate copolymers, anhydride-modified linear low density polyethylene, anhydride-modified very low density polyethylene, and anhydride-modified high density polyethylene, or blends thereof. More preferably, the second adhesive layer comprises an ethylene/methyl acrylate copolymer or a blend of at least two different ethylene/methyl acrylate copolymers.

Each of the foregoing materials is compatible with the interior core layer. Suitable ethylene/methyl acrylate copolymers are commercially available from DuPont under the tradenames Elvaloy® AC and Bynel®. Suitable anhydride-modified ethylene/methyl acrylate copolymers are commercially available from DuPont under the tradenames Bynel® CXA 2169 and Bynel® CXA 2174, and from Quantum Chemicals under the tradename Plexar® 3382. Anhydride-modified linear low density polyethylene is commercially available from Mitsui under the tradenames Admer® NF 500 and NF 550, and from DuPont under the tradename Bynel® 41E689. Each of the other materials that can be used for adhesive layers is also commercially available.

An example of a five-layer film of this invention is a film comprising or produced from (1) a first exterior layer comprising a material selected from the group consisting of a homopolymer or copolymer of polypropylene; (2) a first interior layer comprising an ethylene/α-olefin copolymer having a density ranging from about 0.86 to about 0.94 g/cc; (3) a first interior adhesive layer comprising an ethylene/α-olefin copolymer having a density ranging from about 0.86 to about 0.94 g/cc; (4) a second interior adhesive layer comprising at least one ethylene/alkyl acrylate copolymer; and (5) a second exterior layer comprising a composition comprising or produced from (a) from 90 to 99.9 weight % of one or more polyester-polyether block copolymers; and (b) from 0.1 to 10 weight % of a nucleating agent.

The multilayer films are not limited to the five-layer structure above. Films having a fewer number of layers or more than five layers are included within the invention.

Various additives may be used including, without limitation, antiblocking agents, antioxidants, slip agents, processing aids such as calcium stearate, pigments, antistatic agents, etc. Where the multilayer film is to be used to for making medical solution pouches, the amount of additive included in the film can be kept to a minimum in order to minimize the likelihood that such additives may be extracted into the medical solution during heat-sterilization.

The multilayer films can be formed as a tubular film by blown coextrusion or a flat film by cast extrusion. Containers can be made directly from the coextruded blow molding or injection molding, tubular film, or alternatively from rollstock material obtained from the tube after it has been slit and ply-separated. Blown film can keep the inside surface of the film sterile. Pouch made from blown films may have optical properties inferior to those made from a cast coextrusion. Other processes, such as extrusion coating, conventional lamination, slot die extrusion, etc., can also be used to make the multilayer film.

Pouches for Medical Solutions

A pouch for the packaging and administration of medical solutions can comprise any of the multilayer films disclosed above for they possess good optical properties (i.e., transmission, clarity, and haze) after the medical solution-containing pouches have been heat-sterilized. Such post-sterilization optical properties are much better than polyolefin-based films known in the art. The multilayer films disclosed above exhibit other performance criteria desired in a medical solution pouch. That is, the multilayer films have good flexibility/collapsibility and mechanical strength, and are able to withstand high-temperature sterilization. In addition, the films provide good barrier properties. The films can also be used in other applications using a homogeneous ethylene/α-olefin core layer.

A multilayer film can have a five-layer structure for forming flexible pouches with which to package and administer medical solutions, which include saline solutions, dextrose solutions, solutions for dialysis applications, and others. The multilayer film can include an interior core layer, a first exterior layer, a second exterior layer, a first adhesive layer positioned between and in adherence with the interior core layer and the first exterior layer, and a second adhesive layer positioned between and in adherence with the interior core layer and the second exterior layer.

The multilayer film may have a total thickness ranging from about 3 mils (76 μm) to 14 mils (355 μm), 5 mils (127 μm) to 10 mils (275 μm), or 6.5 mils (165 μm) to 9.5 mils (240 μm) (1 mil=0.001 inch=0.0254 mm=25.4 μm). Exterior layers and may range in thickness from about 0.5 mils (13 μm) to about 8 mils (200 μm) or about 0.75 mils (19 μm) in thickness. Adhesive layers may range in thickness from about 0.2 mils (5 μm) to about 1.5 mils (37 μm) or about 0.8 mils (20 μm) in thickness. The interior core layer may range in thickness from about 1 mil (25 μm) to about 9 mils (230 μm) or about 3.5 mils (90 μm) in thickness.

The interior ethylene/α-olefin copolymer layer may be relatively thick in comparison to the other layers of the film. Such relative thickness facilitates layer in carrying out its primary functions of imparting flexibility, strength, and barrier properties to the multilayer film. An interior ethylene/α-olefin copolymer layer can be considered to be a core layer.

The interior core layer may have the impact on the optical properties of a medical solution pouch made from the film after that pouch has been heat-sterilized. The melting point is high enough such that the film remains intact during the heat-sterilization process; provide adequate barrier properties, especially to oxygen and water vapor; be processible (e.g., coextrudable) with the other layers of the film; and impart sufficient flexibility to the film that a medical solution pouch made therefrom can drain properly. These properties are desirable for a core layer in a multilayer film used to make medical solution pouches. Homogeneous ethylene/α-olefin copolymer, or blend of ethylene/α-olefin copolymers, of this layer may have a density ranging from about 0.89 to about 0.92 g/cc or about 0.90 to about 0.91 g/cc, providing each of the foregoing properties.

The first exterior layer may serve as a heat-seal layer. When the multilayer film is formed into a medical solution pouch, the first exterior layer may form the inside surface of the pouch, i.e., the surface which is in contact with the packaged medical solution. This layer forms a heat-seal when the film is folded upon itself or mated with another film such that two regions of the first exterior layer are brought into contact with one another and sufficient heat is applied to predetermined segments of the contacting regions of that layer so that the heated segments become molten and intermix with one another. Upon cooling, the heated segments of the first exterior layer become a single, essentially inseparable layer. The heated segments of the first exterior layer produce a liquid-tight closure which is commonly referred to as a heat seal. The heat seals thus formed may be fin-shaped and linked together to define the peripheral boundaries of the pouch so that a medical solution can be fully enclosed therein.

Pouches made by the multilayer films may be sealed by various means well known in the art, including impulse and hot-bar sealing. An example of a commercially available impulse-type sealing device is a Vertrod™ heat sealer. The heat seals that form the top and bottom of the pouch (generally shorter in length than the sides of the pouch) may be formed in the machine direction of the multilayer film (i.e., the direction in which the film moved through the production equipment), verses the transverse direction (which is perpendicular to the machine direction).

When an elastomer is blended with polypropylene such that the weight % of elastomer ranges from about 5 to about 50 (based on the total weight of layer), heat-seals can be produced. Heat-seals can also be obtained with about 10 to 40 or about 10 to 30 wt % elastomer. Such heat-seals consistently withstand severe conditions encountered by medical solution pouches such as heat-sterilization, pressure-cuff application, and general rough handling.

The second exterior layer forms the outside surface of the pouch. The exterior layer provides heat-resistance to the pouch during heat-sealing and heat-sterilization and abuse-resistance from external handling and abrasion. This second exterior layer can comprise a nucleated agent such as copolyetherester.

Multilayer films can also be cross-linked. Cross-linking increases the film structural strength at elevated temperatures. Cross-linking can be done by any means of cross-linking techniques such as peroxide chemical cross-linking techniques or irradiation techniques such as electron beam irradiation or gamma irradiation. Irradiation includes bombarding the film with particulate or non-particulate radiation such as high-energy electron beams or cobalt-60 γ-rays. The amount of dosage and penetration depth of irradiation are critical for improving film heat resistance and at the same time maintain its heat seal integrity. Irradiation dosage level can be in the range of 2 to 18 Mrads or 12 to 16 Mrads. Penetration depth depends on the total film thickness. Exposure of the first exterior layer (i.e. the seal layer) to an irradiation source is preferably minimized.

The multilayer films can also be used in other applications such as tubing for transferring medical solutions; blow molded bottles; or thermoformed trays.

The following Examples are merely illustrative, and are not to be construed as limiting the scope of the invention.

### EXAMPLES

### General Procedures Used to Prepare the Laminates

The materials used in the examples are identified below. All percentages are weight percents unless indicated otherwise. All physical property and compositional values are approximate.

CoPEPET1 was a copolyetherester comprising 57.5% 1,4-butylene terephthalate, 24.5% 1,4-butylene isophthalate, 12.5% poly(tetramethylene ether) terephthalate and 5.5% poly(tetramethylene ether) isophthalate. The poly(tetramethylene ether) glycol used to make the copolyetherester had a molecular weight of about 975 and a melting point of 168° C.

CoPEPET2 was a copolyetherester comprising 36% 1,4-butylene terephthalate and 64% poly(tetramethylene ether) terephthalate. Poly(tetramethylene ether) glycol used to make the copolyetherester had a molecular weight of about 2000. The copolymer had a melting point of 193° C.

Sodium stearate was a T1 grade obtained from Crompton.

MB1 was a master batch containing 10% sodium stearate and 90% CoPEPET1.

MB2 was a master batch containing 10% sodium stearate and 90% CoPEPET2.

MB3 was a master batch containing 10% Di(paramethylbenzylidene) sorbital (Irgaclear DM from Ciba)+90% CoPEPET1.

EMA-1 was an ethylene/methyl acrylate copolymer containing 24% MA, having a melt index (MI) of 2; produced by DuPont.

EMA-2 was an ethylene/methyl acrylate copolymer containing 24% MA, having a melt index (MI) of 20; produced by DuPont.

EMA-3 was an ethylene/butyl acrylate copolymer containing 17% BA, having a melt index (MI) of 1.5, produced by DuPont.

Ionomer-1 was an ethylene/methacrylic acid copolymer partially neutralized with sodium ions and having a melt index (MI) of 0.9 (DuPont).

PE-1 was a polyolefin plastomer containing 12% octene, having a MI of 1; available as Affinity PL1880 produced by Dow.

PP-1 was a polypropylene copolymer, having a melt flow rate (MFR) of 5.5; available as Adsyl 3C30FHP produced by Basell.

PP-2 was a polypropylene copolymer, having a melt flow rate (MFR) of 2; available as Profax SR257M produced by Basell.

MI was measured at 190° C. with 2.16 kg mass and MFR was measured at 230° C. with 2.16 kg mass.

### Examples 1-6, Comparative Example C1

Monolayer blown films were prepared from a composition comprising a CoPEPET1 plus a nucleating master batch at various addition levels. The nucleating master batch was made by incorporating 10% of sodium stearate into the copolyetherester using a 30 mm Werner & Pfleiderer twin-screw compounder at set temperature of 210° C. The sodium stearate (T1 grade) was commercially available from Crampton Corporation.

The master batch was then dry blended with the bulk amount of copolyetherester at 5 to 30% levels, resulting in sodium stearate levels of 0.5 to 3%. One-mil thick monolayer films were made on a Brabender blown film machine (screw/die diameter of 30/40 mm) at a processing temperature of about 230° C. A comparative film sample of 100% copolyetherester was made using the same processing equipment and conditions (Comparative Example C1). Optical properties (total haze) along with DSC crystallization points were measured on these film samples to check the nucleation effectiveness. The total haze measurements were done using ASTM D1003 protocols. DSC was used most frequently to study the crystallization behavior of a polymer melt and to determine the activity of a nucleating agent. Crystallization temperature increases with increasing activity (effectiveness) of the nucleating agent. Results shown in Table 1 show that nucleated compositions increased crystallization points and improved haze compared to the nonnucleated composition.

TABLE 1

| Exam- | | Total | Crystallization |
|---|---|---|---|
| ple | Composition | Haze (%) | Point (° C.) |
| C1 | 100% CoPEPET1 | 7 | 67 |
| 1 | 5% MB1 + 95% CoPEPET1 | 3.5 | 129 |
| 2 | 10% MB1 + 90% CoPEPET1 | 2.2 | 129 |
| 3 | 15% MB1 + 85% CoPEPET1 | 1.7 | 130 |
| 4 | 20% MB1 + 80% CoPEPET1 | 1.35 | 130 |
| 5 | 22.5% MB1 + 77.5% CoPEPET1 | 1.3 | 130 |
| 6 | 30% MB1 + 70% CoPEPET1 | 2 | 129 |

### Examples 7-14, Comparative Example C2

Melt blends of two copolyetheresters and corresponding master batches were made. Master batches of sodium stearate and copolyetherester were melt-compounded using a 30-mm Werner & Pfleiderer twin-screw compounder at set temperature of about 210° C. The master batches were then added into the corresponding copolyetherester at various levels by melt-compounding using the same 30-mm Werner & Pfleiderer twin screw compounder at set temperature of about 210° C.

DSC crystallization points were measured on these blends to check nucleation effectiveness. The results in Table 2 show that use of nucleation agents increased the crystallization point.

TABLE 2

| | | Crystallization | |
|---|---|---|---|
| Example | Composition | Point (° C.) | MI |
| C1 | 100% CoPEPET1 | 67 | 14.8 |
| 7 | 95% CoPEPET1 + 5% MB1 | 131 | 17.5 |
| 8 | 90% CoPEPET1 + 10% MB1 | 136 | 21.2 |
| 9 | 85% CoPEPET1 + 15% MB1 | 139 | 27.2 |
| 10 | 80% CoPEPET1 + 20% MB1 | 141 | 32.9 |
| C2 | 100% CoPEPET2 | 124 | 12.2 |
| 11 | 95% CoPEPET2 + 5% MB2 | 167 | 11 |
| 12 | 90% CoPEPET2 + 10% MB2 | 172 | 9.2 |
| 13 | 85% CoPEPET2 + 15% MB2 | 177 | 10.1 |
| 14 | 80% CoPEPET2 + 20% MB2 | 176 | 8.1 |

### Examples 15-16 and Comparative Examples C3-C4

Five-layer blown films were made on a commercial scale W&H line with die diameter of 225 mm at a processing temperature of 234° C.

Comparative Example 3: CoPEPET1/EMA-1/PE-1/PE-1/PP-1

Comparative Example 4. CoPEPET2/EMA-1/PE-1/PE-1/PP-1

Example 15: CoPEPET1+20% MB1/EMA-1/PE-1/PE-1/PP-1

Example 16: CoPEPET2+20% MB1/EMA-1/PE-1/PE-1/PP-1

Results of haze testing are shown in Table 3. Both total haze and internal haze measurements were done using the same hazemeter using similar samples. The total haze measurements were done using ASTM D1003 protocols. Internal haze measurements were conducted similarly, except that mineral oil was applied to both sides of the film prior to the internal haze measurement. Applying oil effectively eliminates the effects of surface roughness on the haze measurement.

TABLE 3

| Example | Total Haze (%) |
|---|---|
| Comparative Example C3 | 52 |
| Comparative Example C4 | 49 |
| 15 | 16 |
| 16 | 23 |

### Examples 17-20 and Comparative Example C5

Multilayer blown films were made on a lab scale Brampton 3-layer line with die diameter of 50 mm at a processing temperature of 210° C. Results of haze testing are shown in Table 4.

Example 17: CoPEPET1+5% MB3/EMA-1/PP-2

Example 18: CoPEPET1+10% MB3/EMA-1/PP-2

Example 19: CoPEPET1+15% MB3/EMA-1/PP-2

Example 20: CoPEPET1+20% MB3/EMA-1/PP-2

Comparative Example C5: CoPEPET1/EMA-1/PP-2

TABLE 4

| Example | Total Haze (%) |
|---|---|
| Comparative Example C5 | 10 |
| 17 | 5 |
| 18 | 5 |
| 19 | 5 |
| 20 | 4 |

### Examples 21-22 and Comparative Examples C6-C7

Three-layer blown films were made on a lab scale Brampton 3-layer line with a die diameter of 50 mm at 210° C. Results are shown in Table 5.

Example 21: CoPEPET2+10% Ionomer-1/EMA-1/PP-2

Example 22: CoPEPET2+10% Ionomer-1/EMA-3/PP-2

Comparative Example C6: CoPEPET2/EMA-1/PP-2

Comparative Example C7: CoPEPET2/EMA-3/PP-2

TABLE 5

| Example | Total Haze (%) | Internal Haze (%) |
|---|---|---|
| Comparative Example C6 | 20 | 16 |
| Comparative Example C7 | 22 | 14 |
| Example 21 | 19 | 3 |
| Example 22 | 20 | 3 |

1. A composition comprising, or produced from, about 90 to about 99.9 weight % of at least one polyester-polyether block copolymer and about 0.1 to about 10 weight % of a nucleating agent wherein the polyester-polyether block copolymer comprises repeat units derived from about 30 to about 70 weight % of 1,4-butylene terephthalate and from about 10 to about 70 weight % of poly(tetramethylene ether) terephthalate.

2. The composition of claim 1 wherein the nucleating agent is an alkali metal salt of a carboxylic acid, di-(optionally substituted)-benzylidene sorbitol, an ethylene/acid copolymer partially neutralized with at least one metal ion, talc, low molecular weight polypropylene, or combinations of two or more thereof.

3. The composition of claim 2 wherein the at least one polyester-polyether block copolymer comprises repeat units derived from 55 to 60 weight % of 1,4-butylene terephthalate, 23 to 27 weight % of 1,4-butylene isophthalate, 10 to about 15 weight % of poly(tetramethylene ether) terephthalate, and 3 to 7 weight % of poly(tetramethylene ether) isophthalate; and the nucleating agent is an alkali metal salt of a carboxylic acid, di-(optionally substituted)-benzylidene sorbitol, an ethylene/acid copolymer partially neutralized with at least one metal ion, or combinations of two or more thereof.

4. The composition of claim 2 wherein the at least one polyester-polyether block copolymer comprises repeat units derived from 30 to 40 weight % of 1,4-butylene terephthalate and 60 to 70 weight % of poly(tetramethylene ether) terephthalate; and the nucleating agent is an alkali metal salt of a carboxylic acid, an ethylene/acid copolymer partially neutralized with at least one metal ion, or both.

5. A multilayer structure comprising or produced from at least one interior layer, a first exterior layer, and a second exterior layer wherein the interior layer comprises or is produced from at least one ethylene/α-olefin copolymer having a density ranging from about 0.86 to about 0.94 g/cc, or an ethylene/alkyl acrylate copolymer, and combinations thereof; the first exterior layer comprises or is produced from a homopolymer, copolymer or terpolymer of polypropylene, a blend of homopolymer, copolymer or terpolymer of polypropylene and elastomer, a high density polyethylene, copolyester, or combinations of two or more thereof; and the second exterior layer comprises a composition as recited in claim 2.

6. The multilayer structure of claim 5 wherein the composition is the same as recited in claim 3.

7. The multilayer structure of claim 5 wherein the composition is as recited in claim 4.

8. The multilayer structure of claim 5 further comprising or further produced from a second interior layer comprising an ethylene/α-olefin copolymer having a density ranging from about 0.86 to about 0.94 g/cc and a third interior adhesive layer comprising at least one ethylene/alkyl acrylate copolymer.

9. The multilayer structure of claim 8 wherein the composition is the same as recited in claim 3.

10. The multilayer structure of claim 8 wherein the composition is as recited in claim 4.

11. The multilayer structure of claim 5 wherein the interior layer comprises the at least one ethylene/alkyl acrylate copolymer and the first exterior layer comprises the homopolymer, copolymer or terpolymer of polypropylene.

12. The multilayer structure of claim 11 wherein the composition is the same as recited in claim 3.

13. The multilayer structure of claim 11 wherein the composition is as recited in claim 4.

14. An article comprising or produced from a multilayer structure wherein the multilayer structure is a film, a sheet, a molded article, or combinations of two or more thereof, the article is a pouch, a tubing, blow molded bottle, a thermoformed tray, or combinations of two or more thereof, and the multilayer structure is as recited in claim 5.

15. The article of claim 14 wherein the multilayer structure is as recited in claim 6.

16. The article of claim 14 wherein the multilayer structure is as recited in claim 7.

17. The article of claim 14 wherein the multilayer structure is as recited in claim 8.

18. The article of claim 14 wherein the multilayer structure is as recited in claim 9.

19. The article of claim 14 wherein the multilayer structure is as recited in claim 10.

20. The article of claim 14 wherein the multilayer structure is as recited in claim 11.

21. The article of claim 14 wherein the multilayer structure is as recited in claim 12.

22. The article of claim 14 wherein the multilayer structure is as recited in claim 13.

23. The article of claim 14 wherein the article is the pouch.

24. The article of claim 15 wherein the article is the pouch.

25. The article of claim 18 wherein the article is the pouch.

26. The article of claim 21 wherein the article is the pouch.

27. The article of claim 14 wherein the article is the tubing.

28. The article of claim 14 wherein the article is the bottle.

29. The article of claim 14 wherein the article is the tray.
